(19) United States
(12) Patent Application Publication
(10) Pub. No.: US 2021/0337644 A1
(43) Pub. Date: Oct. 28, 2021

(54) LIGHT EMITTING DEVICE AND LIGHT GENERATING METHOD

(71) Applicant: Coretronic Corporation, Hsin-Chu (TW)

(72) Inventors: Guo-Cheng Hung, Hsin-Chu (TW); Ho-Yi Yeh, Hsin-Chu (TW); Nan-Jiun Yin, Hsin-Chu (TW)

(73) Assignee: Coretronic Corporation, Hsin-Chu (TW)

(21) Appl. No.: 17/207,726

(22) Filed: Mar. 21, 2021

(30) Foreign Application Priority Data
Apr. 24, 2020 (CN) 202010330937.0

(51) Int. Cl. H05B 45/56; H05B 45/375

(52) U.S. Cl. CPC H05B 45/56; H05B 45/375

(57) ABSTRACT

The disclosure provides a light emitting device including a power conversion circuit configured to provide a power voltage, a light source module receives the power voltage, a driving circuit, and a control circuit. The driving circuit is configured to drive a plurality of light emitting units in the light source module and detect a current value flowing through each light emitting unit to generate a current signal. The control circuit is coupled to the power conversion circuit, the light source module, and the driving circuit and is configured to detect a cross-voltage of at least one of the light emitting units. The control circuit calculates a voltage offset value according to a difference between the cross-voltage and the power voltage to generate a control signal according to the voltage offset value and the current signal to accordingly control the power conversion circuit to adjust the power voltage.

### CROSS-REFERENCE TO RELATED APPLICATION

This application claims the priority benefit of China application serial no. 202010330937.0, filed on Apr. 24, 2020. The entirety of the above-mentioned patent application is hereby incorporated by reference herein and made a part of this specification.

### BACKGROUND

### Technical Field

The disclosure relates to a light emitting device, and in particular, to a light emitting device capable of dynamically adjusting a power voltage.

### Description of Related Art

In the existing panel technology, light emitting units including light emitting elements (e.g., a light-emitting diode (LED)) are evenly arranged on a panel in series, in parallel, or both.

The panel is provided with a power cord to provide a fixed power voltage to drive the light emitting units. FIG. 1 is a schematic view of arrangement of light emitting units of a panel. With reference to FIG. 1, in order to lower costs, a power cord is generally disposed in a corner of a panel 100 (e.g., the left side of the panel as shown in FIG. 1) and is wired to be connected to each one of light emitting units 1011 in a plurality of light emitting unit strings 101 and 102-112, and the power cord provides a power voltage VDD.

FIG. 2 is a schematic view of a structure of a single light emitting unit in FIG. 1. With reference to FIG. 2, a light emitting unit 200 includes a light emitting element 210 and a control circuit 220. The light emitting element 210 is coupled between the power voltage VDD and the control circuit 220. The control circuit 220 is coupled between the light emitting element 210 and a reference ground voltage GND and includes a switch 221 (e.g., a metal-oxide-semiconductor field-effect transistor (MOSFET) or a bipolar junction transistor (BJT)) coupled in series and a resistor 222. Herein, the switch 221 may control turning on/off of a path of the light emitting unit 200 through a pulse width modulation (PWM) signal, so as to affect the light emitting element 210 to emit light or not to emit light. A driving voltage configured to drive the light emitting unit 200 is a sum of the wiring voltage drop, a starting voltage of the light emitting element 210, and a voltage drop of the control circuit 220.

Configuration of the panel 100 is provided in a concise manner in FIG. 1, so that some circuits are omitted. In particular, each light emitting unit 1011 may include one or plural light emitting elements 210 connected in series, and each light emitting unit 1011 and another end coupled to the power voltage VDD may be connected to the reference ground voltage GND through the control circuit 220. In this way, a driving current may flow through the light emitting unit 1011, the control circuit 220, and the reference ground voltage GND in sequence from the power voltage VDD.

With reference to FIG. 1 and FIG. 2 together, since distances between the light emitting units 1011 and the power voltage VDD are different, wiring lengths are different and wiring electrical impedances are also different. Further, the power voltage VDD actually received by each one of the light emitting units 1011 has a different degree of voltage drop caused by factors such as aging and damage of wiring, the actual degree of aging of the light emitting element 210 itself, and the ambient temperature. Nevertheless, the light emitting units 1011 may not be driven if insufficient power voltage VDD is provided. Therefore, on the premise of being capable of coping with the worst case, a circuit designer usually increases the voltage value of the source power voltage VDD. Generally, the design of the source power voltage VDD is thereby higher than that of the cross-voltages of the light-emitting units 1011 by 30% to 60%. Nevertheless, the worst case may not necessary happen. The configured higher power voltage VDD is thereby too high for light emitting units 1011 that are not in the worst case, which may lead to power consumption and overheating of the control circuit 220. A solution capable of coping with various cases including the worst case, providing a sufficient power voltage VDD to drive each light emitting unit 1011, and not leading to power consumption and circuit overheating is therefore required.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The disclosure provides a light emitting device and a light generating method capable of solving problems of power consumption and circuit overheating caused by an excessively high power voltage being provided.

Other features and advantages of the embodiments of the invention are illustrated by the technical features broadly embodied and described as follows.

For one or some or all of the aforementioned objects or for other objects, an embodiment of the disclosure provides a light emitting device including a power conversion circuit, a light source module, a driving circuit, and a control circuit. The power conversion circuit is configured to provide a power voltage. The light source module includes a plurality of light emitting units and is coupled to the power conversion circuit to receive the power voltage. The driving circuit is coupled to the light source module, is configured to drive a plurality of light emitting units, and is configured to detect a current value flowing through each light emitting unit to generate a current signal. The control circuit is coupled to the power conversion circuit, the light source module, and the driving circuit and is configured to detect a cross-voltage of at least one of the light emitting units. The control circuit calculates a voltage offset value according to a difference between the cross-voltage and the power voltage to generate a control signal according to the voltage offset value and the current signal, so as to accordingly control the power conversion circuit to adjust the power voltage.

An embodiment of the disclosure provides a light generating method suitable for a light emitting device, and the light emitting device includes a power conversion circuit, a light source module, a driving circuit, and a control circuit. The light generating method includes the following steps. A power voltage is provided by the power conversion circuit. The power voltage is received by the light source module. A plurality of light emitting units in the light source module are driven and a current value flowing through each light emitting unit is detected by the driving circuit to generate a current signal. A cross-voltage of at least one of the light emitting units is detected and a voltage offset value is calculated according to a difference between the cross-voltage and the power voltage by the control circuit to generate a control signal according to the voltage offset value and the current signal, so as to accordingly control the power conversion circuit to adjust the power voltage.

To sum up, the embodiments of the invention have at least one of the following advantages or effects. In the disclosure, the magnitude of the power voltage may be adjusted according to the current signals of the light emitting units and the voltage offset value between the cross-voltages of the light emitting units and the power voltage. Accordingly, on the premise that all the light emitting units may be driven, the power voltage may be kept at the minimum value in the disclosure, so that the problems of power consumption and circuit overheating are prevented.

In order to make the aforementioned and other features and advantages of the invention more comprehensible, several embodiments accompanied with figures are described in detail below.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of arrangement of light emitting units on a panel.

FIG. 2 is a schematic view of a structure of a single light emitting unit in FIG. 1.

FIG. 3 is a schematic block view of a light emitting device according to an embodiment of the disclosure.

FIG. 4 is a flow chart of a light generating method according to an embodiment of the disclosure.

### DESCRIPTION OF THE EMBODIMENTS

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

In the following detailed description of the preferred embodiments, reference is made to the accompanying drawings which form a part hereof, and in which are shown by way of illustration specific embodiments in which the disclosure may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting.

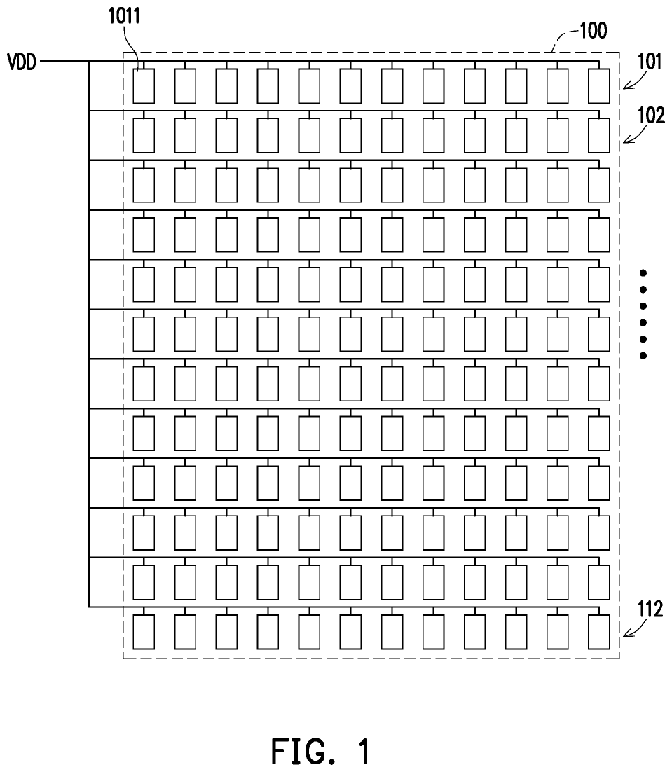

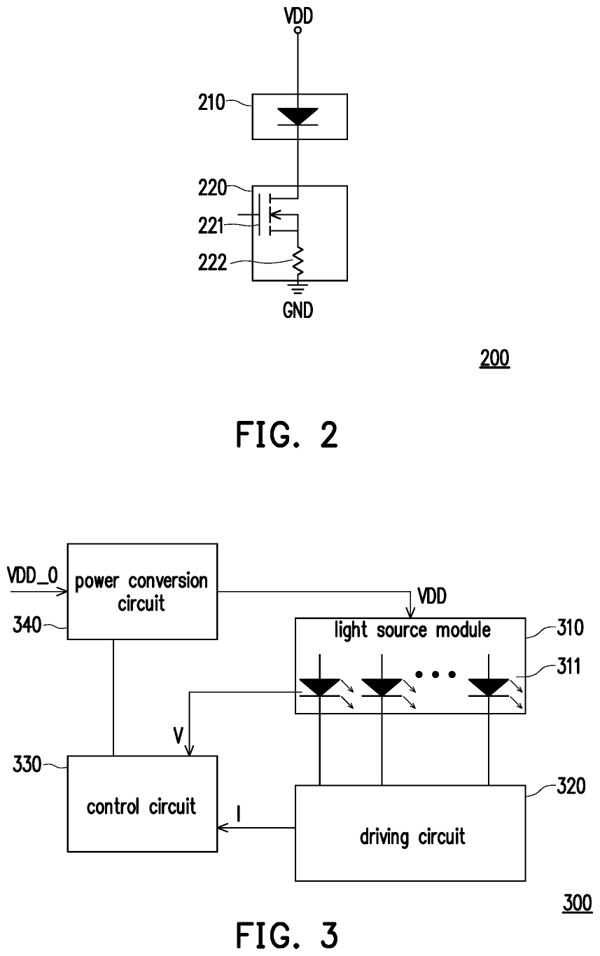

FIG. 3 is a schematic block view of a light emitting device according to an embodiment of the disclosure. With reference to FIG. 3, a light emitting device 300 includes a light source module 310, a driving circuit 320, a control circuit 330, and a power conversion circuit 340. Arrangement of the light emitting units on the panel shown in FIG. 1 and FIG. 2 may be applied to the light source module 310. The power conversion circuit 340 is configured to generate a power voltage VDD according to an input voltage VDD_0 and provide the power voltage VDD to the light source module 310. The input voltage VDD_0 is provided by, for example, an external power source of a display. The light source module 310 includes a plurality of light emitting units 311, and the plurality of light emitting units 311 are, for example, light emitting diodes (LEDs). The light source module 310 is coupled to the power conversion circuit 340, so that each light emitting unit 311 in the light source module 310 may receive the power voltage VDD. Regarding a structure of each light emitting unit 311, the structure of each light emitting unit 200 shown in FIG. 2 may be referenced, and description thereof is thus omitted. The driving circuit 320 is, for example, an LED driving circuit or includes an LED driving circuit and other electronic driving circuits. The driving circuit 320 is coupled to the light source module 310, so as to drive the plurality of light emitting units 311 in the light source module 310 through a PWM signal. Further, the driving circuit 320 is also configured to detect a current value flowing through each light emitting unit 311 to generate a current signal I.

The control circuit is, for example, a microprocessor, a central processing unit (CPU), or a programmable microprocessor for general or special use, a digital signal processor (DSP), a programmable controller, an application specific integrated circuit (ASIC), a programmable logic device (PLD), or other similar devices or a combination of the foregoing devices. The control circuit 330 is coupled to the power conversion circuit 340, the light source module 310, and the driving circuit 320. The control circuit 330 is coupled to the light source module 310 and is configured to detect a cross-voltage V of at least one of the light emitting units 311. To be specific, the cross-voltage V refers to the cross-voltage of each light emitting element 210 shown in FIG. 2 or of each light emitting unit 311 shown in FIG. 3. The definition of the cross-voltage is common knowledge for a person of ordinary skill in the art. The control circuit 330 calculates a voltage offset value according to a difference between the cross-voltage V and the power voltage VDD provided to the light source module 310 by the power conversion circuit 340. The control circuit 330 may generate a control signal according to the voltage offset value and the current signal I detected by the driving circuit 320, so as to accordingly control the power conversion circuit 340 to adjust magnitude of the power voltage VDD. In an embodiment, the control circuit 330 includes a remote sensing function to acquire the cross-voltage V and adjusts the magnitude of the power voltage VDD according to the cross-voltage V and the detected current signal I.

To be specific, the control circuit 330 may compare the current signal I of each light emitting unit 311 detected by the driving circuit 320 with a default threshold. In the case that the current signal I is greater than the threshold, the control circuit 330 may determine that the corresponding light emitting unit 311 is in a normal operating state. In a contrary case, the light emitting unit 311 may be determined to be in an abnormal operating state. For instance, the power voltage VDD received by the light emitting unit 311 may be excessively low such that the light emitting unit 311 may not be driven.

Further, the control circuit 330 may control the power conversion circuit 340 to lower the power voltage VDD when confirming that all current signals I of the light emitting units 311 in the light source module 310 are greater than the threshold. In contrast, the control circuit 330 may control the power conversion circuit 340 to increase the power voltage VDD when confirming that the current signal I of any of the light emitting units 311 in the light source module 310 is less than the threshold (indicating that a light emitting unit 311 is not driven). The control circuit includes the threshold. The threshold may be stored in the control circuit 330 in the form of software or firmware. Nevertheless, in other embodiments, the control circuit 330 may be coupled to a general storage device to store the threshold. In this embodiment, the power conversion circuit 340 may be a DC-DC buck converter.

In an embodiment, when the power voltage VDD is 5V, all current signals I of the light emitting units 311 in the light source module 310 detected by the driving circuit 320 are greater than the threshold, for example, 0 amperes (A). Herein, the threshold may also be configured to be 100 microamperes (μA) to exclude misjudgment caused by leakage currents of the light emitting units 311. At this time, the control circuit 330 may transmit the control signal to the power conversion circuit 340 to control the power conversion circuit 340 to output a power voltage VDD of, for example, 4.9V. In contrast, when the power voltage VDD is lowered to 2.5V, the driving circuit 320 detects that the current signal I of at least one light emitting unit 311 in the light source module 310 is less than the threshold. At this time, the control circuit 330 may transmit the control signal to the power conversion circuit 340 to control the power conversion circuit 340 to output a power voltage VDD of, for example, 2.6V. That is, an adjustment range of the power voltage VDD is 0.1V.

Nevertheless, the adjustment range is not limited to be 0.1V only in the disclosure. In other embodiments, the control circuit 330 may further dynamically adjust the adjustment range of the power voltage VDD according to a voltage difference between the detected cross-voltage V of the at least one light emitting unit 311 and the current power voltage VDD. The number of the at least one light emitting unit 311 may be one, and such light emitting unit 311 may be one light emitting unit 311 farthest from the power cord (one end of the power voltage VDD), such as one light emitting unit 1011 in the light emitting unit string 112 in the lower right corner of the panel 100 shown in FIG. 1. Without knowing the configuration of the panel power cord, the number of the the at least one light emitting unit 311 may be four, and the four light emitting units 311 are disposed in four corners of the panel. For instance, the light emitting units located in the upper right corner (the light emitting unit string 101), the lower right corner (the light emitting unit string 112), the upper left corner (not labeled), and lower left corner (not labeled) in the panel 100 are the four light emitting units 1011 located in four corners of the panel 100 shown in FIG. 1. The light source module 310 is disposed in the region range of the panel.

The control circuit 330 may adopt and treat a maximum value among the four cross-voltages V corresponding to the four light emitting units as a basis for determining the adjustment range of the power voltage VDD. Nevertheless, the number of the light emitting units 311 detected by the control circuit 330 is not limited to be one or four in the disclosure. In other embodiments, based on the size of a panel, the number of the light emitting units 311 detected by the control circuit 330 may be six, eight, or other numbers. In addition, the cross-voltage V detected by the control circuit 330 may also act as a basis for evaluating a degree of aging of the light emitting elements on the panel.

The control circuit 330 may calculate and treat the voltage difference between the detected cross-voltage V of the at least one light emitting unit 311 and the current power voltage VDD to act as the voltage offset value. Therefore, for instance, the maximum value among the four cross-voltages V corresponding to the four light emitting units is adopted to act as the basis for determining the adjustment range of the power voltage VDD, and the light emitting unit producing the minimum obtained voltage offset value is adjusted. In this way, all light emitting elements in the panel 100 are prevented from not emitting light (not to be turned on) caused by excessive adjustment range. The control circuit 330 may adjust the adjustment range of the power voltage VDD according to the voltage offset value. For instance, on the premise that all current signals I of the light emitting units 311 in the light source module 310 are greater than the threshold, when the current power voltage VDD is 5V and the cross-voltage V is 3V, the voltage offset value calculated by the control circuit 330 is 2V. At this time, the control circuit 330 may send the control signal to lower the power voltage VDD by 1V (that is, 4V). When the current power voltage VDD is 4V and the cross-voltage V is 3V, the voltage offset value calculated by the control circuit 330 is 1V. At this time, the control circuit 330 may send the control signal to lower the power voltage VDD by 0.5V (that is, 3.5V). When the current power voltage VDD is 3.5V and the cross-voltage V is 3V, the voltage offset value calculated by the control circuit 330 is 0.5V. At this time, the control circuit 330 may send the control signal to lower the power voltage VDD by 0.1V (that is, 3.4V). The above lowering process may continue until the driving circuit 320 detects that the current signal I of one light emitting unit 311 in the light source module 310 is less than the threshold. When the current signal I is less than the threshold, the control circuit 330 may control the power voltage VDD instead to be increased by 0.1V or other values.

That is, the control circuit 330 may have multiple numerical ranges by default. When the voltage offset value is greater than or equal to 2V, the control circuit 330 may set the adjustment range of the power voltage VDD to be 1V. When the voltage offset value is between 1V and 1.9V, the control circuit 330 may set the adjustment range of the power voltage VDD to be 0.5V. When the voltage offset value is less than 1V, the control circuit 330 may set the adjustment range of the power voltage VDD to be 0.1V. Nevertheless, the numerical range configured to determine the adjustment range of the power voltage VDD is not limited in the disclosure. In other embodiments, a designer may set the numerical range and the corresponding adjustment range of the power voltage VDD in consideration of factors such as the panel size and the wiring width.

Referring to FIG. 3 again, a variable resistor (not shown) may be disposed inside the power conversion circuit 340, and a resistance value range thereof may be, for example, 0 to 2 kilo-ohms (KΩ). The power conversion circuit 340 may adjust the resistance value within a range of 0 to 2KΩ according to the control signal sent by the control circuit 330. A voltage value of the power voltage VDD generated by the power conversion circuit 340 may be inversely related to the resistance value of the variable resistor. For instance, when the control circuit 330 sends a control signal corresponding to the resistance value of 0Ω, the power conversion circuit 340 may adjust the variable resistor to be 0Ω according to such control signal, so that the input voltage VDD_0 generates the power voltage VDD of a maximum value of, for example, 5V according to the voltage division principle. When the control circuit 330 sends a control signal corresponding to the resistance value of 2KΩ, the power conversion circuit 340 may adjust the variable resistor to be 2KΩ according to such control signal, so that the input voltage VDD_0 generates the power voltage VDD of a minimum value according to the voltage division principle. When the light emitting device 300 is turned on, the control circuit 330 may send a control signal corresponding to a predetermined resistance value (e.g., 1KΩ, so that the power conversion circuit 340 generates the power voltage VDD of a median value.

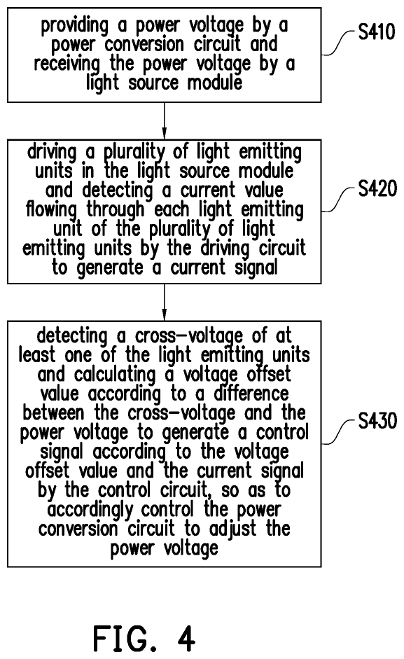

FIG. 4 is a flow chart of a light generating method according to an embodiment of the disclosure. With reference to FIG. 4, the light generating method is suitable for a light emitting device as shown in FIG. 3, and the light emitting device includes a power conversion circuit, a light source module, a driving circuit, and a control circuit. The light generating method includes steps S410 to S440. With reference to FIG. 3 and FIG. 4 together, in step S410, the power conversion circuit 340 provides the power voltage VDD, and the light source module 310 receives the power voltage VDD. In step S420, the driving circuit 320 drives the plurality of light emitting units 311 in the light source module 310 and detects the current value flowing through each light emitting unit 311 of the plurality of light emitting units to generate the current signal I. In step S430, the control circuit 330 detects the cross-voltage V of at least one of the light emitting units 311 and calculates a voltage offset value according to a difference between the cross-voltage V and the power voltage VDD to generate a control signal according to the voltage offset value and the current signal I, so as to accordingly control the power conversion circuit 340 to adjust the outputted power voltage VDD.

In view of the foregoing, in the disclosure, the power voltage may be gradually lowered on the premise that the current value of each light emitting unit is greater than the threshold. Further, in the disclosure, the adjustment range of lowering may be determined according to the difference between the cross-voltage of at least one of the light emitting units and the current power voltage. Therefore, on the premise that all the light emitting units may be driven, the power voltage may be kept at the minimum value in the disclosure, so that the problems of power consumption and circuit overheating are prevented.

The above are exemplary embodiments of the disclosure and should not be construed as limitations to the scope of the disclosure. That is, any simple change or modification made based on invention of the claims and specification of the invention falls within the scope of the invention. Any of the embodiments or any of the claims of the disclosure does not necessarily achieve all of the advantages or features disclosed by the disclosure. Moreover, the abstract and the title are merely used to aid in search of patent files and are not intended to limit the scope of the claims of the disclosure. In addition, terms such as “first” and “second” in the specification or claims are used only to name the elements or to distinguish different embodiments or scopes and should not be construed as the upper limit or lower limit of the number of any element.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A light emitting device, comprising a power conversion circuit, a light source module, a driving circuit, and a control circuit, wherein:
the power conversion circuit is configured to provide a power voltage,
the light source module comprises a plurality of light emitting units and is coupled to the power conversion circuit to receive the power voltage,
the driving circuit is coupled to the light source module, and is configured to drive the plurality of light emitting units and detect a current value flowing through each light emitting unit to generate a current signal, and
the control circuit is coupled to the power conversion circuit, the light source module, and the driving circuit and is configured to detect a cross-voltage of at least one of the light emitting units, wherein the control circuit calculates a voltage offset value according to a difference between the cross-voltage and the power voltage to generate a control signal according to the voltage offset value and the current signal, so as to accordingly control the power conversion circuit to adjust the power voltage.

2. The light emitting device according to claim 1, wherein the control circuit comprises a threshold, and the current signal adjusts the control signal to lower the power voltage when the control circuit is greater than the threshold.

3. The light emitting device according to claim 1, wherein the control circuit further comprises a threshold, and the current signal adjusts the control signal to increase the power voltage when the control circuit is less than the threshold.

4. The light emitting device according to claim 1, wherein the plurality of light emitting units are disposed in the region range of a panel, the control circuit detects cross-voltages of the plurality of light emitting units in a plurality of corners located in the region range, so as to generate a voltage signal according to a maximum voltage value among the cross-voltages of the plurality of light emitting units.

5. The light emitting device according to claim 1, wherein:
the power conversion circuit comprises a variable resistor, and the power conversion circuit adjusts a resistance value of the variable resistor according to the control signal, so as to adjust the power voltage provided to the light emitting device.

6. A light generating method, adapted to a light emitting device, wherein the light emitting device comprises a power conversion circuit, a light source module, a driving circuit, and a control circuit, wherein the light generating method comprises:
providing a power voltage by the power conversion circuit;
receiving the power voltage by the light source module;
driving a plurality of light emitting units in the light source module and detecting a current value flowing through each light emitting unit of the plurality of light emitting units by the driving circuit to generate a current signal; and detecting a cross-voltage of at least one of the light emitting units and calculating a voltage offset value according to a difference between the cross-voltage and the power voltage by the control circuit to generate a control signal according to the voltage offset value and the current signal, so as to accordingly control the power conversion circuit to adjust the power voltage.

7. The light generating method according to claim 6, wherein the light generating method further comprises:
adjusting the control signal to lower the power voltage by the control circuit when the current signal is greater than a threshold.

8. The light generating method according to claim 6, wherein the light generating method further comprises:
adjusting the control signal to increase the power voltage by the control circuit when the current signal is less than a threshold.

9. The light generating method according to claim 6, wherein the plurality of light emitting units are disposed in a region range of a panel, wherein the light generating method further comprises:
detecting cross-voltages of the plurality of light emitting units in a plurality of corners located in the region range by the control circuit, so as to generate a voltage signal according to a maximum voltage value among the cross-voltages of the plurality of light emitting units.

10. The light generating method according to claim 6, wherein the power conversion circuit comprises a variable resistor, wherein the light generating method further comprises:
adjusting a resistance value of the variable resistor according to the control signal by the power conversion circuit, so as to adjust the power voltage provided to the light emitting device.
